(19) United States
(12) Patent Application Publication
(10) Pub. No.: US 2020/0269495 A1
(43) Pub. Date: Aug. 27, 2020

(54) ADDITIVE MANUFACTURING BUILD MATERIAL DOSE CONTROL

(71) Applicant: HEWLETT-PACKARD DEVELOPMENT COMPANY, L.P., Spring, TX (US)

(72) Inventor: Arthur H. Barnes, Vancouver, WA (US)

(21) Appl. No.: 16/608,435

(22) PCT Filed: Nov. 10, 2017
(86) PCT No.: PCT/US2017/061066

§ 371 Date: Oct. 25, 2019

(51) Int. Cl. B29C 64/153; B33Y 10/00; B33Y 30/00; B33Y 50/02; B29C 64/393; G01F 23/292

(52) U.S. Cl. CPC B29C 64/153; B33Y 10/00; G01F 23/292; B33Y 50/02; B29C 64/393; B33Y 30/00

(57) ABSTRACT

Some examples include an additive manufacturing machine including a build chamber including a build area and a dose plate, a build material dispenser to dispense a mass of a build material onto the dose plate, a light source to transmit a light energy through the build material on the dose plate, a light sensor to sense a light energy transmitted through the build material on the dose plate, and a controller to control the build material dispenser to adjust a next build material dose mass based on a sensed light energy transmission.

### BACKGROUND

Additive manufacturing machines produce three dimensional (3D) objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into layers, each defining that part of a layer or layers of build material to be formed into the object.

### BRIEF DESCRIPTION OF THE DRAWINGS

FIG. 1A is a schematic side view of an example additive manufacturing system in accordance with aspects of the present disclosure.

FIG. 1B is a schematic top view of an example additive manufacturing system of FIG. 1A in accordance with aspects of the present disclosure.

FIG. 2 is a flow chart of an example method of operating an additive manufacturing machine in accordance with aspects of the present disclosure.

FIG. 3A is a schematic side view of an example additive manufacturing system in a first pass of a build cycle in accordance with aspects of the present disclosure.

FIG. 3B is a schematic top view of the example additive manufacturing system of FIG. 3A in accordance with aspects of the present disclosure.

FIG. 4 is a schematic top view of an example additive manufacturing system in a second pass of a build cycle in accordance with aspects of the present disclosure.

FIG. 5A is a schematic side view of an example additive manufacturing system in a third pass of a build cycle in accordance with aspects of the present disclosure.

FIG. 5B is a schematic top view of the example additive manufacturing system of FIG. 5A in accordance with aspects of the present disclosure.

FIG. 5C is a partial exploded side view the example additive manufacturing system of FIG. 5A in accordance with aspects of the present disclosure.

FIG. 6 is a schematic side view of an example additive manufacturing system completing the third pass of a build cycle in accordance with aspects of the present disclosure.

FIG. 7 is a schematic side view of an example additive manufacturing system during a fourth pass of a build cycle in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The descriptions and examples provided herein can be applied to various additive manufacturing technologies, environments, and materials to form a three dimensional (3D) object based on data of a 3D object model. Various technologies can differ in the way layers are deposited and fused, or otherwise solidified, to create a build object, as well as in the materials that are employed in each process.

In an example additive manufacturing process, a build material and a printing agent can be deposited and heated in layers to form a build object. An example additive manufacturing technology can dispense a build material and spread the build material onto a build surface to form a layer of build material. The build surface can be a surface of a platen or underlying build layers of build material on a platen within a build chamber, for example. The example additive manufacturing technology can dispense a suitable printing agent in a desired pattern onto the layer of build material and then expose the build material and the printing agent to an energy source, such as a thermal energy source for fusing. Sintering, or full thermal fusing, can be employed to fuse small grains of build material, e.g., powders. Sintering typically involves heating the build material to melt and fuse the particles together to form a solid object and can include pressure.

In some additive manufacturing technologies, the layer of build material may be formed using a roller or a recoater. A printhead may be used to dispense a printing agent, such as a fusing agent or a binder, on a formed layer of build material. The recoater and printhead may be carried on a moving carriage system. The moving carriage system may comprise, in different examples, either a single carriage or multiple carriages. A build material dispensing assembly can be mounted to the moving carriage system to dispense and spread build material to form a layer of build material. A printhead can be employed to selectively dispense fusing agent, or another kind of printing agent can be mounted to the moving carriage system. A thermal energy source can also be mounted on the carriage system and moved across the build surface. The energy source can generate heat that is absorbed by fusing energy absorbing components of the printing agent to sinter, melt, fuse, or otherwise coalesce the patterned build material. In some examples, the energy source can apply a heating energy, suitable to heat the build material to a pre-fusing temperature, and a fusing energy, suitable to fuse the build material where the printing agent has been applied. Thermal, infrared, or ultraviolet energy can be used, for example, to heat and fuse the material. The patterned build material can solidify and form an object layer, or a cross-section, of a desired build object. The process is repeated layer by layer to complete the 3D build object.

In an example additive manufacturing process using selective laser sintering (SLS) technology, a layer of build material is formed and a thermal heat source, such as a laser, is used to selectively heat and fuse portions of the layer of the build material in a build pattern. With SLS technology, the patterned build material can melt and solidify to form an object layer, or a cross-section, of a desired build object. The process is repeated layer by layer to complete the three dimensional (3D) build object.

In another example, a layer of build material is formed and a liquid printing agent (e.g., a chemical binding agent) is selectively deposited to bind the build material together in a select build pattern. A printhead can be used to dispense the binding agent on a formed layer of build material. The patterned build material can solidify to form an object layer, or a cross-section, of a desired build object. In one example, an energy source can be used to dry, or cure, the binding agent. As with previously described examples, the process is repeated layer by layer to complete the three dimensional (3D) build object.

Build material can be a powder-based type of build material and the printing agent can be an energy absorbing liquid that can be applied to the build material, for example. Build material 26 can include plastic, ceramic, and metal powders, and powder-like material, for example. In some examples, build material 26 can be formed from, or may include, short fibers that may, for example, have been cut into short lengths from long strands or threads of material. Other types of build materials can also be acceptable. Build material can allow at least partially light transmittance.

Accurate control of each dose of incoming build material into the build chamber is desirable. Variations in the incoming build material dose mass or uniformity can cause undesirable variations in physical and thermal interactions of the incoming dose with the build parts in the chamber. Build material dose mass variations can be disruptive to the thermal balance of the build process of the 3D build object. For example, variations in the build mass dose can cause excursions (e.g., modulations) in warming energy power levels as the warming source attempts to adjust to accommodate the dose mass variation and warm the build material consistently from layer to layer.

The build material dose can be dispensed onto a dose plate prior to being spread onto the build surface. The build material dose can be dispensed onto a dose plate adjacent the build surface to assist with control of the dose. Variations in distribution (e.g., mass, thickness) of the incoming build material dose along a length of the dose plate can cause uneven build material thickness across the build surface. For example, delivery of a small dose, on a section or the entire length of the dose plate, of build material relative to the expected nominal dose can cause inadequate build material mass, or volume, to fill the layer, or uneven layer thickness that can result in overheating of build parts. The variations of incoming build material doses resulting in variations in warming energy power levels or the build material layer thickness can cause over or under fusing of build parts, resulting in part defects and material property variations. It is desirable to monitor and control the build material dose delivery during the build process to reduce dose mass variation thermal and physical effects resulting in improved material properties and reducing part defects. A closed loop control system can be useful to control dose mass during the build process.

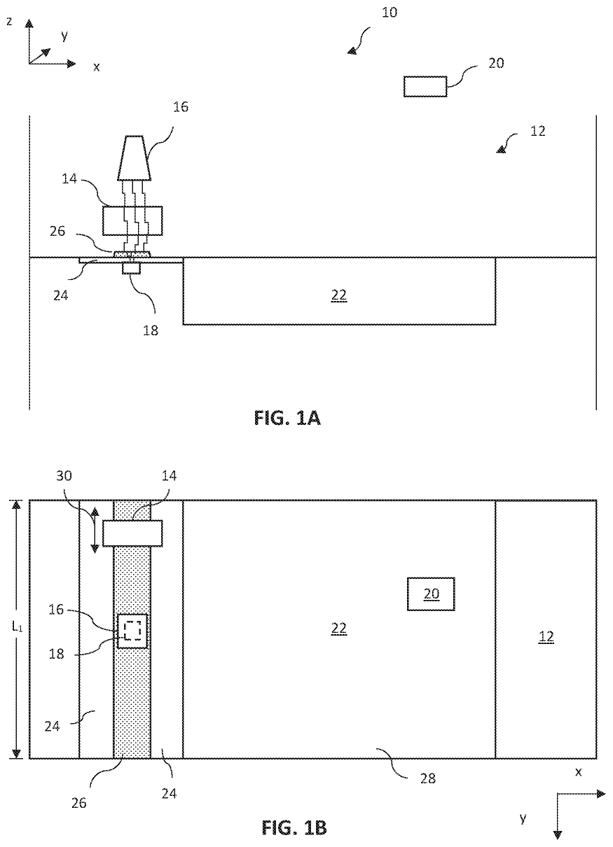

FIG. 1A is a schematic side view of an example additive manufacturing system in accordance with aspects of the present disclosure. Additive manufacturing system 10 includes a build chamber 12, a build material dispenser 14, a light source 16, light sensor 18, and a controller 20. Build chamber 12 includes a build area 22 and a dose plate 24. As described further below, build material dispenser 14 can dispense a mass of a build material 26 onto dose plate 24. Light source 16 can emit a light energy onto dose plate 24. Light sensor 18 can sense a light energy transmission from light source 16 through build material 26 on dose plate 24. Controller 20 can control build material dispenser 14. Controller 20 can adjust a next build material dose mass or volume to be dispensed from build material dispenser 14 based on a sensed light energy transmission received by light sensor 18 through a previously dispensed dose of build material 26 on dose plate 24. The next build material dose can be a new build material dose disposed on dose plate 24 after the presently sensed build material dose is removed from dose plate 24 or can be an adjustment to the build material dose presently sensed on dose plate 24. Light source 16, light sensor 18, controller 20, and build material dispenser 14 can be employed as a closed loop feedback and control of build material 26 delivery onto dose plate 24, for example, as described further below.

With additional reference to FIG. 1B, FIG. 1B is a schematic top view of the example additive manufacturing system of FIG. 1A in accordance with aspects of the present disclosure. As illustrated, in one example, dose plate 24 can be disposed adjacent to build area 22. Dose plate 24 and can have a length Li (along the y-axis) equal to or greater than a build surface length. In one example, at least a first surface 25a that build material 26 is dispensed upon is planar. A quantity of build material 26 suitable for a layer of the build object is deposited, or delivered, onto dose plate 24 by build material dispenser 14 prior to being spread onto a build surface 28 of build area 22. The dispensed build material 26 is suitable to provide a mass, or volume, of build material 26 sufficient to be spread into a complete layer on build surface 28 of build area 22. In one example, build material 26 is deposited as a layer across length Li of dose plate 24. In one example, build material dispenser 14 is a dispensing spreader, such as a ribbon spreader, for example, that deposits and spreads build material 26 to form a strip layer of build material 26 having a thickness on dose plate 24. In one example, build material dispenser 14 can be carried on a carriage to be movable bi-directionally in the y-axial direction across dose plate 24 to distribute build material 26 as indicated by arrow 30.

Build material 26 can be dispensed onto dose plate 24 to form a layer having a thickness. The thickness is the same, or substantially the same, throughout the strip of build material 26 on dose plate 24, for example. The thickness of build material 26 on dose plate can be suitable for light transmission to be received by light sensor 18 and can vary based on the type of build material 26 used. For example, the layer of build material 26 can be between 0 to 4 millimeters (mm) thick. In some examples, a greater thickness can also be acceptable. Light sensor 18 is suitable to detect and sense light energy emitted from light source 16 transmitted through build material 26 disposed on dose plate 24.

Light source 16 can emit a constant, or substantially constant, level of light energy during the build process. Light source 16 can be stationary or movable within build chamber 12. Light source 16 can be directed toward dose plate 24 along a first side and light sensor 18 can be disposed on a second side opposite the first side. In one example, light source 16 can be statically mounted in a z-axial direction relative to dose plate 24 (i.e., above or below) across from light sensor 18 with build material 26 dispensed onto dose plate 24 between light source 16 and light sensor 18. In one example, a single light source 16 is used. In another example, more than one light source 16 is used. In one example, light source 16 is a laser oriented to emit a laser beam toward the dose plate and light sensor 18. In one example, light source 16 is fusing energy source that is movable over dose plate 24. In another example, light source 16 is a light source independent of the fusing energy source. In one example, a single light source 16 is included to emit light energy toward one or several light sensors 18. In another example, multiple light sources 16 can be included. For example, a light source 16 can be included to correspond with each light sensor 18. In another example, a light source 16 can be included to correspond with a group, or series, of light sensors 18.

Light sensor 18 can absorb light energy from light source 16. Light sensor 18 can be a thermopile or a phototransistor, for example, although other light sensors can also be acceptable. In one example, dose plate 24 is transparent and light sensor 18 is disposed adjacent a surface of dose plate 24, opposite light source 16. In another example, light sensor 18 is disposed within dose plate 24, for example, within an aperture formed within dose plate 24. In one example, light sensor 18 is disposed in an aperture of dose plate 24. In one example, multiple light sensors 18 can be used. Light sensors 18 can be arranged in a pattern along dose plate 24. For example, light sensors 18 can be arranged orthogonally along dose plate 24. Multiple light sensors 18 can be arranged in any pattern suitable to detect and sense light energy emitted from light source 16 and transmitted through build material 26 disposed on dose plate 24 and provide information on thickness and density, for example, of build material 26 based on the light energy transmission received. Use of multiple light sensors 16 can be distributed along dose plate 24 to increase sensed light energy collection over a surface area of dose plate 24. In one example using multiple light sensors 18, the light energy transmission received by each of multiple light sensors 18 can be averaged.

Light sensor 18 can transmit a light energy signal to controller 20 to provide information such as material thickness and density, for example, of build material 26 disposed on dose plate 24 based on the light energy received through build material 26 emitted from light source 16. Controller 20 can determine a mass (e.g., a first mass) of the dose of build material 26 dispensed from build material dispenser 14 onto dose plate 24 and control build material dispenser 14 in second and future doses of build material 26 based on the light energy signal transmitted from light sensor 18 to controller 20. Controller 20 can be a proportional integral derivative (PID) controller or any other suitable type of controller.

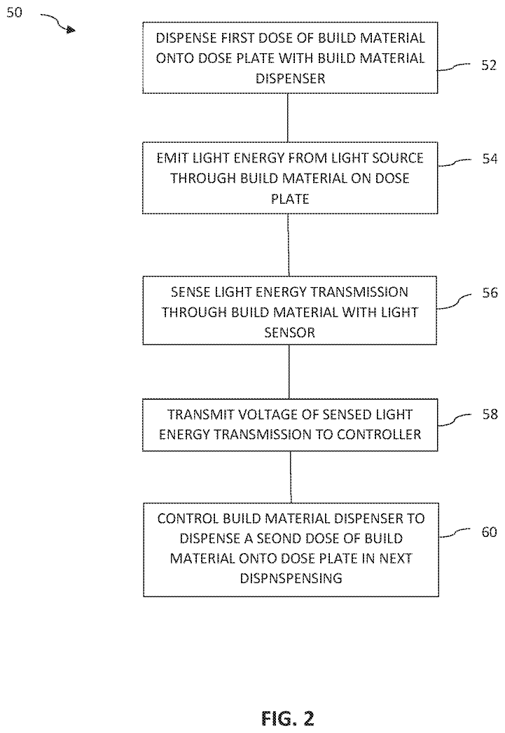

FIG. 2 illustrates an example method 50 of additive manufacturing. At 52, a first dose of a build material is dispensed onto a dose plate with a build material dispenser. At 54, a light energy is emitted from a light source through the build material on the dose plate. At 56, a light energy transmission is sensed through the build material with a light sensor. At 58, a voltage of a sensed light energy transmission is transmitted to a controller. At 60, a build material dispenser is controlled to dispense a second dose of the build material onto the dose plate in a next build material dose dispensing.

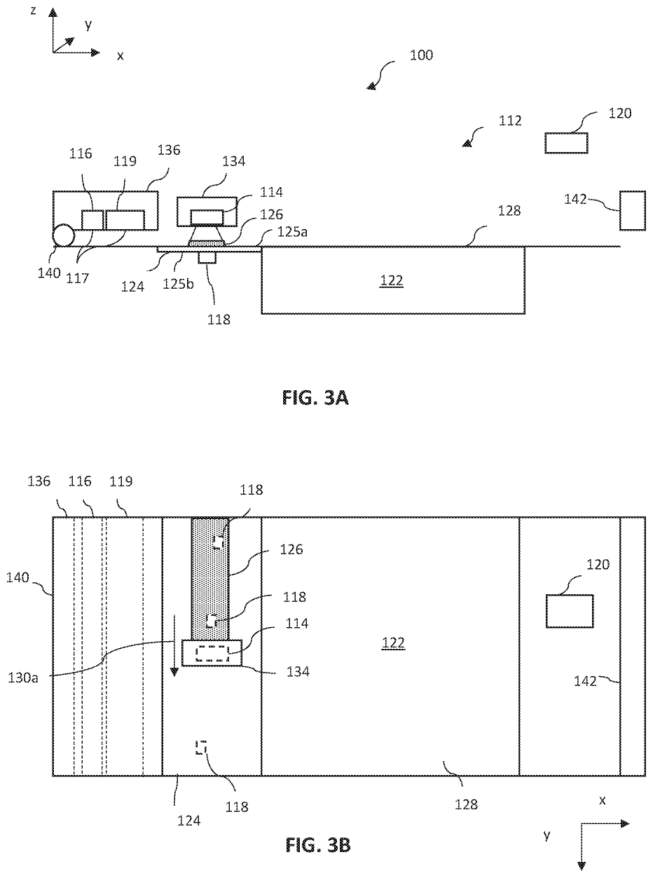

FIGS. 3A-7 are schematic views illustrating a sequence of an example build cycle of an additive manufacturing system 100 in accordance with aspects of the present disclosure. Each pass can include multiple operations that can occur simultaneously during the build cycle. Direction of movement of the passes, in accordance with one example, is indicated by arrows in FIGS. 3A-7. The passes are discussed below as first pass, second pass, third pass, etc. for illustrative purposes only and the build cycle can occur as beginning at any of the passes and include additional or fewer passes. Elements numbered similarly to those above can include features akin to those discussed above.

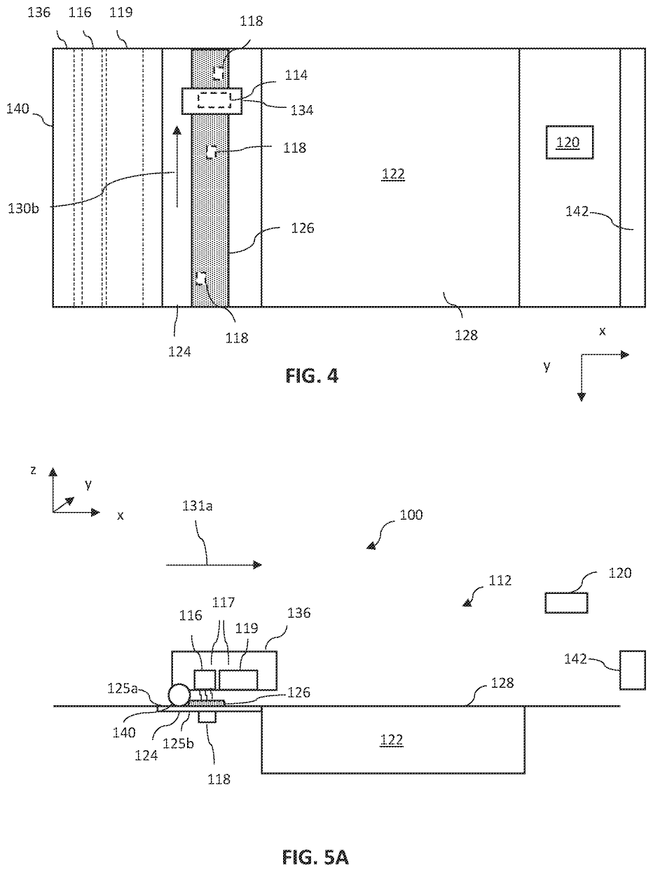

With reference an example first pass illustrated in FIGS. 3A and 3B, a build material dispenser 114 is moved in a first y-axial direction, as indicated by arrow 130a in FIG. 3B, to dispense a build material 126 onto a first surface 125a of a dose plate 124. Traveling across dose plate 124, build material dispenser 114 can dispense and spread a strip of build material 126 having a substantially uniform thickness onto dose plate 124 and over light sensors 118. As illustrated in FIG. 4, build material dispenser 114 is movable in a second pass in a second y-axial direction, opposite the first direction, as indicated by arrow 130b. In some examples, build material 126 can be further dispensed or spread onto first surface 125a of dose plate 124 in the second pass to adjust build material 126 dose on dose plate 124. Adjustments, or corrections, to the build material 126 dose on dose plate 124 can be made during the second pass in response to sensed light energy received by light sensor 118 through build material 126 and transmitted to controller 120. Build material dispenser 114 can be carried, for example, on a first carriage 134 that is bi-directionally movable along the y-axis.

In one example, light source 116 is disposed along, or above, first surface 125a of dose plate 124 and light sensor(s) 118 are disposed along a second surface 125b of dose plate 124, second surface 125b opposite first surface 125a. In another example, light source 116 is disposed along second surface 125b and light sensor(s) 118 can be disposed adjacent first surface 125a. In one example, light sensor(s) 118 can extend within aperture(s) of dose plate 124. In one example, light sensor(s) 114 can extend within aperture(s) to be planar with first surface 125a of dose plate 124. A quantity and arrangement, or pattern, of light sensor(s) 118 can be included as appropriated to sense light energy as a representative measurement of the build material dose on dose plate 124. As illustrated, in one example, multiple light sensors 118 can be included and arranged in an orthogonal pattern along dose plate 124. In other examples, a single light sensor 118 can be included and positioned adjacent or within dose plate 124 as appropriate to sense light energy from light source 116 through build material 126 on dose plate 124. In one example, light sensor 118 is a line scanner extending along a length of dose plate 124. Other arrangements and quantities of lights sensors 118 are also acceptable, as appropriate to sense light energy from a light source 116 through build material 126 on dose plate 124.

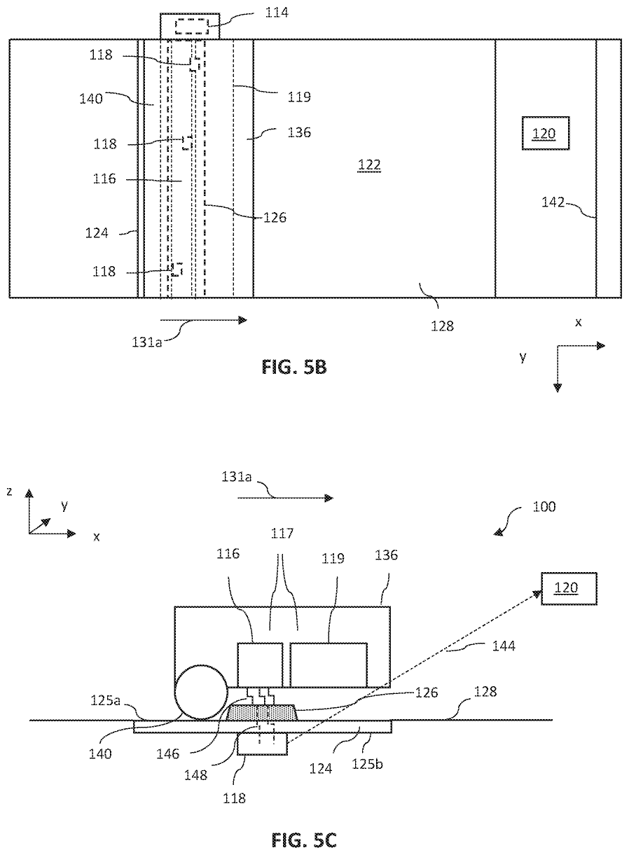

Light source 116 can emit a constant, or substantially constant, level of light energy during the build cycle. In one example, light source 116 can be a fusing energy light source and included as part of a thermal energy source 117 along with warming light source 119. In another example, light source 116 is a non-fusing energy light source. Thermal energy source 117 can heat and cure, or irradiate, build material layer 126a in build area 122 to form an object layer of the build object. In one example, thermal energy source 117 and a spreader 140 can be carried on a second carriage 136, or set of carriages, to provide bi-directional movement along the x-axis over build area 122 within build chamber 112. A bonding or printing agent dispenser carriage 142 can be bi-directionally movable along the x-axis over build area 122 along the same line of motion as carriage 136 so that carriages 136, 142 can follow each other across build area 122. Carriages 136, 142 can be disposed outside of the perimeter of dose plate 124 and build area 122 during the bi-directional passing of build material dispenser 114 across dose plate 124. Build material dispenser 114 can be positioned outside of the path of carriages 136, 142 when not dispensing build material 126 or not otherwise traversing over dose plate 124 (see, e.g., FIG. 5B).

FIGS. 5A-5C illustrate a third pass of system 100 in accordance with aspects of the present disclosure. In this pass, carriage 136 moves light source 116 over build material 126 dispensed on dose plate 124 in the x-axial direction indicated by arrow 131a. Light source 116 can be movable over light sensor 118 disposed within and/or adjacent to dose plate 124 and build area 122. Light source 116 can emit a constant level of energy during the build cycle, and in particular, during passage over light sensors 118. Light sensors 118 can sense and collect light energy transmitted through build material 126 as light source 116 is passed over light sensors 118. At least some of the light energy emitted from light source 116 is transmitted through build material 126 and sensed and collected by light sensor 118.

A dose (e.g., mass or volume) of build material 126 dispensed by build material dispenser 114 onto dose plate 124 can be suitable to form a build material layer and can be slightly more than the dose mass of build material 126 useful to form a build layer completely and with full part coverage in the buildable area due to surface variances of build surface 128, including variations formed in previously formed and fused layers. For example, bonded or fused build material in previously formed layers can compress, or consolidate, leaving the height, or thickness, of the bonded or fused portions (e.g., build part) recessed below the height of non-fused portions forming cavities or recess over a build part due to thermal energy retained in the build part being greater than thermal energy retained in surrounding build material. As the build material 126 dose decreases, there is less build material available to fill the next part cavity which can result in reduced densification of the next downstream part and cause reduced or weakened material properties in the downstream build part. Suitable build material 126 doses can be useful in spreading over build surface 128 to fill part recesses or cavities and control build temperature variations.

An intensity of the sensed light energy collected by light sensor 118 varies as a function of dose mass which is dependent on build material 126 dose thickness and density. Density and thickness of build material 126 on dose plate 124 are indicative of the mass or volume of build material 126. In one example, the density and thickness of build material 126 on dose plate 124 allows light transmission through build material 126 to light sensor 118. In one example, the density and thickness of build material 126 is such that build material 126 is translucent on dose plate 124. Light energy transmitted through build material 126 varies as a function of build material 126 dose mass or volume. In one example, the transmitted signal strength (voltage) varies with the dose mass (grams). For example, a thin low mass or low density dose of build material 126 can have more light energy transmitted through build material 126 and collected by light sensor 118 than a light energy transmitted through a thick high mass or high density dose of build material 126. As build material 126 dose mass, thickness, and density increase, less light energy is transmitted through build material 126 to light sensor 118 and the strength of a sensor signal 144 collected by light sensor 118 and transmitted to controller 120 decreases. The relationship between dose mass (and/or volume) and sensor signal 144 can be used to determine and track dose variation and control upstream (e.g., next or future) dose masses (or volumes) dispensed by build material dispenser 114. In one example, a next, or second, dose mass or volume is equivalent to the sensed first mass or volume of build material on dose plate 124. In another example, the next dose mass or volume is an adjusted dose mass or volume of the first dose mass or volume on dose plate 124. Controller 120 can adjust upstream dose masses dispensed by build material dispenser 114 to reduce dose mass variations based on the transmitted signal strength (voltage) of sensor signal 144.

FIG. 5C illustrates an exploded partial side view of system 100 in accordance with the example of FIG. 5A. Light energy, indicated by lines 146, emitted from light source 116 is transmitted through build material 126 to light sensor 118 as light source 116 is positioned directly above light sensor 118. At least some of the light energy 146 emitted from light source 116 is transmitted through build material 126, as indicated with energy transmission indicated by lines 148 sensed and collected by light sensor 118. Light sensor 118 communicates data corresponding to sensed transmitted light signal with signal strength (voltage output) of sensor signal 144 to controller 120. Controller 120 receives sensor signal 144 and adjusts the next build material 126 dosing parameters (e.g., mass, weight, or volume) based on the sensed transmitted light signal strength to achieve substantially uniform, consistent build material 126 dosages dispensed from build material dispenser 114. Light source 116, light sensor 118, controller 120, and build material dispenser 114 can be employed as a closed loop feedback and control of build material 126 dose delivery that includes sensing and evaluating the dose mass (or volume) by measuring light transmission from light source 116 to light sensor 118 through build material 126 on dose plate 124. In one example, the light energy transmission indicated by lines 148 can be continuously or periodically employed to adjust dosing parameters of future build material 126 doses.

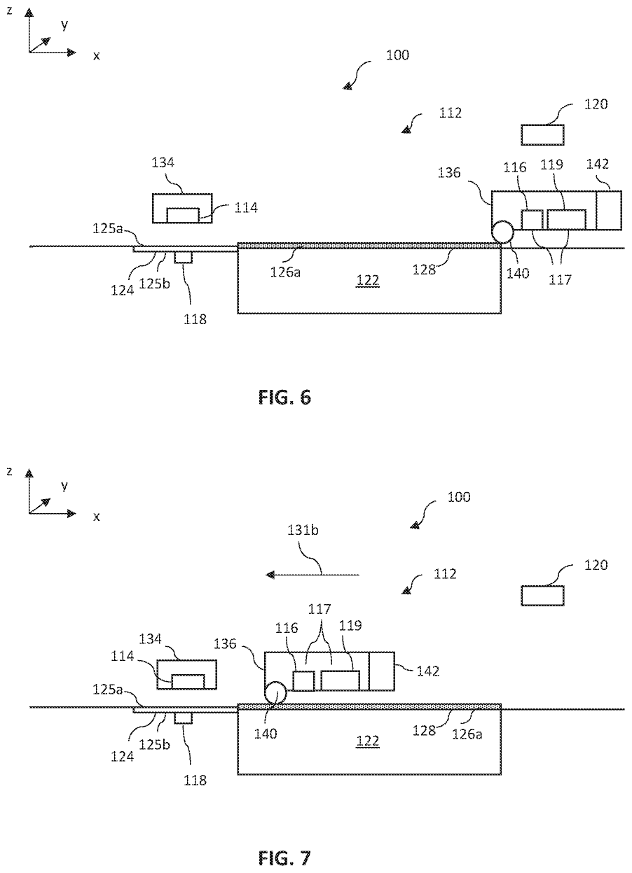

FIG. 6 illustrates a schematic side view of an end state of the third pass of system 100 in accordance with aspects of the present disclosure. In one example, dose plate 124 is stationary and a platen or other structure supporting build surface 128 is vertically adjustable to vertically align build surface 128 with dose plate 124 for spreading layers of build material 126 from dose plate 124 to build surface 128. In general, spreader 140 can spread build material 126 to form a build material layer 126a over build area 122. As illustrated in FIG. 6, build material 126 has been removed from dose plate 124 and spread onto build surface 128 to form build material layer 126a. In one example, as spreader 140 is moved across dose plate 124 to spread build material 126 onto build surface 128, spreader 140 removes all of build material 126 from dose plate 124. Dose plate 124 is cleared and ready for a next build material dose.

FIG. 7 illustrates a schematic side view of a fourth pass of system 100 in accordance with aspects of the present disclosure. Carriages 136, 142 are moved along the x-axis in a second direction, as indicated by arrow 131b. In one example, one or both thermal energy sources 117 emit energy during the third and fourth passes. Agent dispenser carriage 142 carries bonding or printing agent to selectively dispense onto each layer of build material 126 spread over build area 122. Carriages 136, 142 can move completely and entirely across build area 122 and dose plate 124 along the x-axis during the third and fourth pass and can be positioned beyond either side of build chamber 112.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An additive manufacturing machine, comprising:
a build chamber including a build area and a dose plate;
a build material dispenser to dispense a mass of a build material onto the dose plate;
a light source to transmit a light energy through the build material on the dose plate;
a light sensor to sense a light energy transmitted through the build material on the dose plate; and
a controller to control the build material dispenser to adjust a next build material dose mass based on a sensed light energy transmission.

2. The additive manufacturing machine of claim 1, wherein the light sensor is disposed within the dose plate.

3. The additive manufacturing machine of claim 1, wherein the light source is disposed along a first surface of the dose plate and the light sensor is disposed along a second surface of the dose plate opposite the first surface.

4. The additive manufacturing machine of claim 1, wherein the dose plate is disposed adjacent the build surface.

5. The additive manufacturing machine of claim 1, wherein the light sensor is disposed within the dose plate.

6. The additive manufacturing machine of claim 1, wherein the light source is stationary.

7. The additive manufacturing machine of claim 1, wherein the light source is a fusing energy source.

8. A method of additive manufacturing, comprising:
dispensing a first dose of a build material onto a dose plate with a build material dispenser;
emitting a light energy from a light source through the build material on the dose plate;
sensing a light energy transmission through the build material with a light sensor;
transmitting a voltage of a sensed light energy transmission to a controller; and
controlling a build material dispenser to dispense a second dose of the build material onto the dose plate in a next dispensing.

9. The method of additive manufacturing of claim 7, wherein controlling includes:
determining the first dose based on the transmitted voltage; and
comparing the determined first dose to a desired build material dose.

10. The method of additive manufacturing of claim 7, wherein controlling includes adjusting a build material dosing parameter based on the transmitted voltage.

11. The method of additive manufacturing of claim 7, wherein the second dose of the build material is equivalent to the first dose of the build material.

12. An additive manufacturing machine, comprising:
a build chamber including a build surface and a dose plate;
a build material dispenser to dispense a build material mass across the dose plate, the build material having a mass and a thickness on the dose plate;
a light source to emit a constant light energy toward the dose plate;
a light sensor to sense a light energy transmission from the light source through the thickness of the build material on the dose plate and transmit a sensor signal having a strength corresponding to the light energy transmission; and
a controller to receive the sensor signal and to control the build material dispenser to adjust a next build material dose dispensing onto the dose plate based on the strength of the sensor signal.

13. The additive manufacturing machine of claim 12, wherein an intensity of the light energy transmission sensed by light sensor corresponds to the thickness of the build material on dose plate.

14. The additive manufacturing machine of claim 12, wherein an intensity of the light energy transmission sensed by light sensor corresponds to a density of the build material on dose plate.

15. The additive manufacturing machine of claim 12, wherein the light sensor includes at least two sensors.
